(19) United States
(12) Patent Application Publication
(10) Pub. No.: US 2015/0111286 A1
(43) Pub. Date: Apr. 23, 2015

(54) Method and System for Reducing Foam Formation in Slurry Pits of Swine Rearing Facilities with Slatted Floors

(71) Applicant: Biocover A/S, Veerst (DK)

(72) Inventor: Morten Toft, Veerst (DK)

(73) Assignee: Biocover A/S, Veerst (DK)

(21) Appl. No.: 14/085,870

(22) Filed: Nov. 21, 2013

Related U.S. Application Data
(60) Provisional application No. 61/892,071, filed on Oct. 17, 2013.

(51) Int. Cl. C05F 3/00; C05F 3/06

(52) U.S. Cl. CPC C05F 3/00; C05F 3/06
USPC 435/268; 435/286.1

(57) ABSTRACT

The present invention relates to a method and a system for reducing foam formation in slurry pits of swine rearing facilities with slatted floors.

### RELATED APPLICATION

This application claims the benefit of U.S. Provisional Application No. 61/892,071, filed on Oct. 17, 2013. The entire teachings of the above application are incorporated herein by reference.

### TECHNICAL FIELD OF THE INVENTION

The present invention relates to a method and a system for reducing foam formation in slurry pits of swine rearing facilities with slatted floors.

### BACKGROUND OF THE INVENTION

Swine and other livestock are commonly reared in facilities that are specially designed to manage manure and liquid waste generated by such livestock. In some swine rearing facilities, swine are raised in enclosed facilities that have slatted floors. Beneath the floors are pits for receiving swine manure and urine that pass through the slatted floor (FIG. 1). The use of ethanol as an additive to gasoline fuel is increasing, and a substantial amount of corn is being used for the production of the ethanol. When ethanol plants make ethanol, they use only starch from corn. The by-product of this production is called DDGS (Dried Distillers Grains with Solubles). DDGS is very rich in protein and fibre and is a very good food additive for pigs. However, this diet increases the amount of protein in the slurry, which is degraded by bacteria in the pit. This may cause the slurry to build a foam layer in the slurry pits.

The issue of foaming in deep-pit swine rearing facilities with slatted floors is widespread across Iowa and in other Midwestern states in the US. In 2013, it was estimated that 25% were affected. Several inches of foam may build up and cover the surface, and foam depths of 5 feet or more have been observed. Foam traps and holds biogases emitted during anaerobic decomposition of stored manure. Disrupting the manure or foam surface releases bursts of biogas with methane concentrations of 50-70% by volume. When mixed with ambient air, the resulting concentration can be in the explosive range (5-20%). This increases the potential for an explosion or flash fire (flammable gas levels) when a heater, motor, or light switch is activated or when a worker begins spark-inducing maintenance tasks (e.g., grinding or welding). Explosions or flash fires associated with foaming manure have caused extensive building damage. Pigs were severely burned and most had to be immediately sent to market or euthanized. Workers have been injured after being propelled by a blast or exposed to intense heat.

Further problems associated with build up of foam are that the slurry capacity in the slurry pit is reduced, and that the ventilation of the deep-pit swine rearing facilities with slatted floors is blocked. This reduces the swine capacity of the deep-pit swine rearing facilities.

It is known to add monensin through the slat openings to alleviate the problem. However, the long term effect of monensin containing slurry for fertilizing crops for human consumption is at present not known. Furthermore, monensin is toxic to the pigs.

Hence, there is a need for a way of reducing foaming in slurry pits of swine rearing facilities with slatted floors.

### SUMMARY OF THE INVENTION

One object of the present invention is to reduce the foaming in slurry pits of swine rearing facilities with slatted floors.

This object is solved by increasing the pH of the slurry in the slurry pits/deep pits with ammonia, a natural component of slurry. The increase in pH has been found to inhibit the growth of methane producing bacteria, and therefore markedly reduces further foam production in the pit.

One aspect relates to a method for reducing foam formation in deep pits of swine rearing facilities with slatted floors comprising:
i. Transporting at least a part of the slurry from a deep pit of a deep pit swine rearing facility into a premixing system (100) comprising:
   a tank (102) adapted for receiving slurry from the deep pit;
   a recirculation conduit (104) in liquid communication with the tank (102), the recirculation conduit being connected to the tank (102) through an outlet (101) and an inlet (103);
   a recirculation pump means (106) in connection with the recirculation conduit (104), the recirculation pump means (106) being adapted for pumping the slurry from the tank (102) through the recirculation conduit (104) and back into the tank (102), the recirculation pump means (106) being configured for controlling the flow of the slurry through the recirculation conduit (104); wherein the premixing system (100) is in liquid communication with an anhydrous ammonia tank (108);
iia. Adding anhydrous ammonia from the anhydrous ammonia tank (108) into the recirculation conduit (104) while recirculating the slurry, thereby dissolving said anhydrous ammonia in the slurry and forming an alkaline nitrogen enriched pre-mix;
iii. Returning said alkaline nitrogen enriched pre-mix to the deep pit;
   wherein the amount added of anhydrous ammonia is sufficient to result in an alkaline nitrogen enriched pre-mix having a pH within the range of 8.0-9.9.

Another aspect relates to a system for reducing foam formation in deep pits of swine rearing facilities with slatted floors comprising:
a) a premixing system (100) comprising:
   a tank (102) adapted for receiving slurry from the deep pit;
   a recirculation conduit (104) in liquid communication with the tank (102), the recirculation conduit being connected to the tank (102) through an outlet (101) and an inlet (103);
   a recirculation pump means (106) in connection with the recirculation conduit (104), the recirculation pump means (106) being adapted for pumping the slurry from the tank (102) through the recirculation conduit (104) and back into the tank (102), the recirculation pump means (106) being configured for controlling the flow of the slurry through the recirculation conduit (104);
b) an anhydrous ammonia tank (108) in liquid communication with the recirculation conduit (104); and
c) a pH sensor system adapted for measuring the pH value of the slurry in the tank (102) and in the deep pit (300).

### BRIEF DESCRIPTION OF THE FIGURES

The foregoing and other objects, features and advantages of the invention will be apparent from the following more particular description of preferred embodiments of the invention, as illustrated in the accompanying drawings in which like reference characters refer to the same parts throughout the different views. The drawings are not necessarily to scale, emphasis instead being placed upon illustrating the principles of the invention.

FIG. 1 shows a swine rearing facilities with slatted floors;

FIG. 2 shows a chart explaining the effect of a foam layer foe reducing ammonia emission;

FIG. 3 shows methane producing bacterial sensitivity to temperature and pH;

FIG. 4 shows the pH dependant chemical equilibrium between ammonia and ammonium;

FIG. 5 shows the change in use of commercial fertilizer and organic fertilizer over the years in Denmark;

FIG. 6 shows a premixing system integrated into a slurry tanker in accordance with various embodiments of the invention, and a slurry pit with a stirrer; and FIG. 7 shows a premixing system integrated into a slurry tanker in accordance with various embodiments of the invention.

### DETAILED DESCRIPTION OF THE INVENTION

One object of the present invention is to reduce the foaming in slurry pits of swine rearing facilities with slatted floors. This object is solved by increasing the pH of the slurry in the slurry pits/deep pits with ammonia, a natural component of slurry. The increase in pH has been found to inhibit the growth of methane producing bacteria, and therefore markedly reduces further foam production in the pit.

The inventor has found that the best environment for methane producing bacterias is within a pH level range of 6-8, and a temperature range of 30-35 degrees Celsius

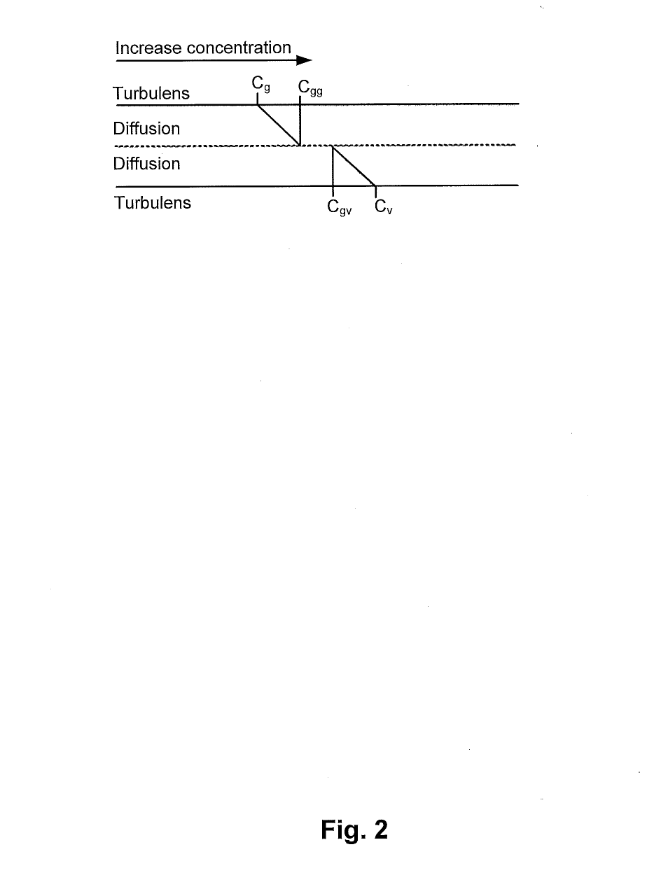

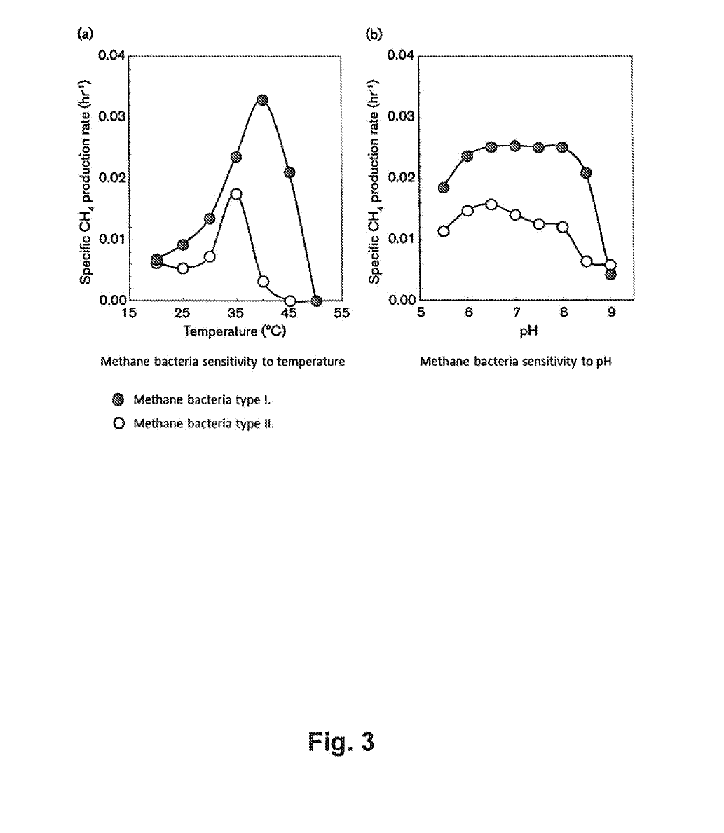

(FIG. 3). Hence, the problem may be solved by adjustment of the pH level, either through acidification of the slurry below 6.0 or increasing the alkaline level to 8.0 or above and/or by increasing the temperature to above 40 degrees Celsius. The foam layer will act as a barrier to the natural release of methane that is generated in the pits. Furthermore, the foam layer is a very effective barrier for ammonia emission. The methane retention of the foam layer is a result of its effect as a physical barrier, while it is the distance to the turbulence area, which creates the emission reduction of ammonia (a diffusion process, FIG. 2). Hence, the treatment should be started when a layer of foam has formed, but has not yet reached a level where it will become a problem. The pH level of swine slurry is normally within the range of 7.0-7.2. Lowering of the pH level of the slurry in pits of swine rearing facilities with slatted floors is very dangerous due to hydrogen sulphur releases from the slurry, as well as substantial amounts of foam is formed due to the release of carbon dioxide from bicarbonates present in the slurry. Increasing the pH level of the slurry does not cause release of hydrogen sulphur or build-up of foam. The inventor has found that when the foaming process starts to be visible, the pH level will have reached to about 7.5, and will increase to 8.0-8.4, when the problem with an excessive foam layer is present. As the pH level is already high at this stage, it requires a relatively low amount of base to increase the pH value and make the slurry toxic for methane producing bacteria.

A wide range of bases would result in a high alkaline level, such as lime. However, ammonia is a natural component of slurry, and widely used as a fertilizer. As ammonia is widely used as a fertilizer, there is no cost to the treatment other than the use of the apparatus, as there is full value of the ammonia as a fertilizer.

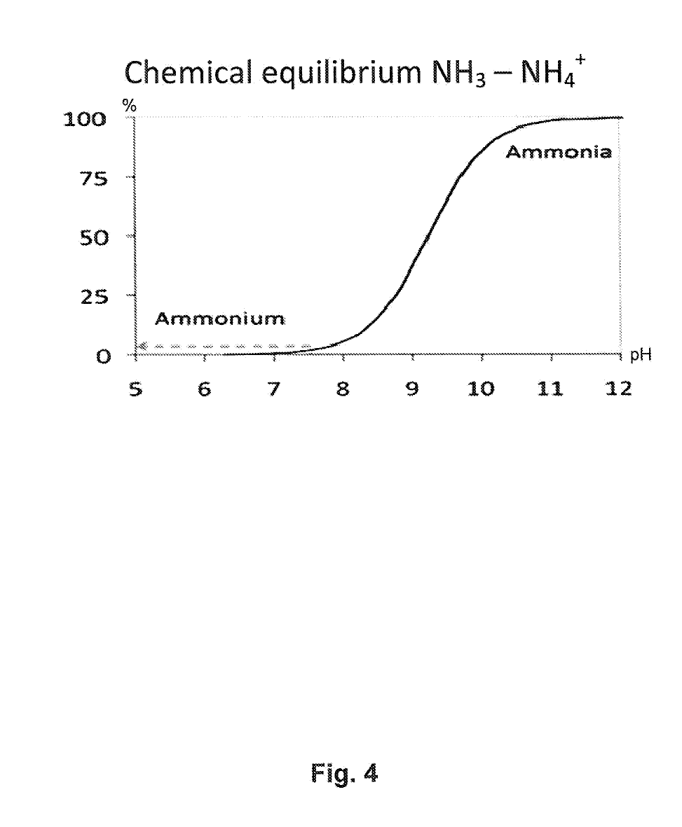

Ammonia and ammonium is in equilibrium when dissolved in a fluid. The pH level regulates the amount of each compound in the fluid. As the foaming slurry normally has a pH of 7.5 to 8.4, it can be seen in FIG. 4, that only a very small increase in pH will transform the existing ammonium to ammonia and thus render the slurry toxic for bacteria. The increase in pH may potentially increase the ammonia emission from the slurry. However, the treatment will not remove the existing foam, which is an effective barrier for ammonia emission.

To avoid increasing the volume of the slurry in the pit, and hence keep the capacity within the pit, the inventor is using anhydrous ammonia as the ammonia source. Anhydrous ammonia cannot be added directly to the pit, due to the risk of explosion due to the highly exothermic reaction and due to the risk of a massive ammonia emission to the surrounding atmosphere.

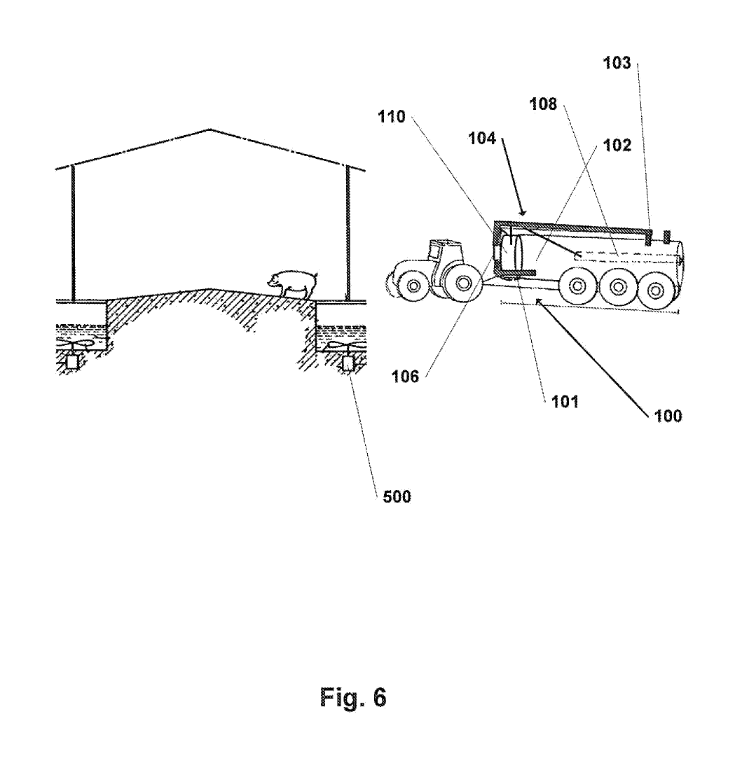

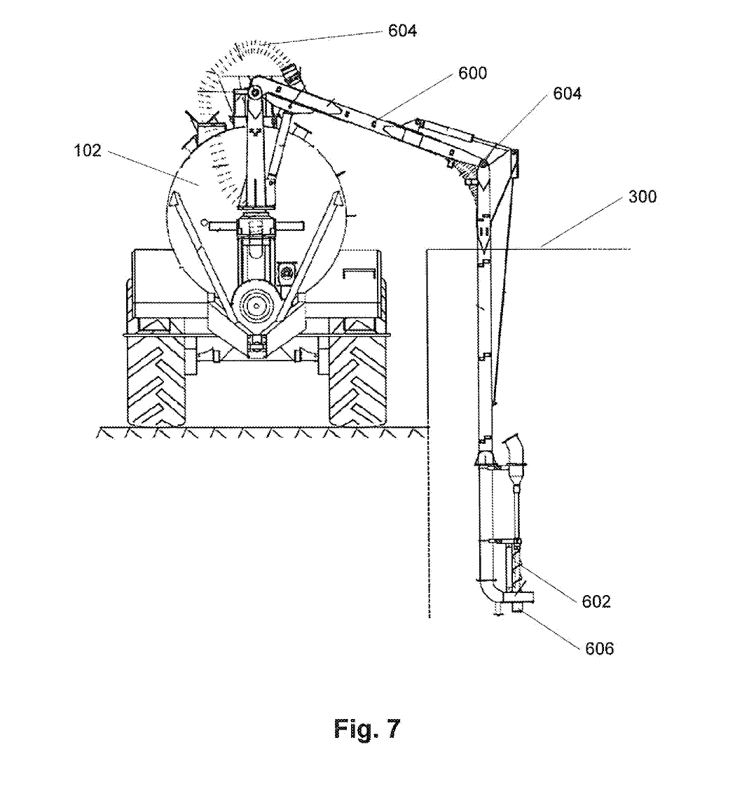

Referring to FIG. 6, one aspect relates to a method for reducing foam formation in deep pits of swine rearing facilities with slatted floors comprising:
i. Transporting at least a part of the slurry from a deep pit of a deep pit swine rearing facility into a premixing system (100) comprising:
   a tank (102) adapted for receiving slurry from the deep pit;
   a recirculation conduit (104) in liquid communication with the tank (102), the recirculation conduit being connected to the tank (102) through an outlet (101) and an inlet (103);
   a recirculation pump means (106) in connection with the recirculation conduit (104), the recirculation pump means (106) being adapted for pumping the slurry from the tank (102) through the recirculation conduit (104) and back into the tank (102), the recirculation pump means (106) being configured for controlling the flow of the slurry through the recirculation conduit (104); wherein the premixing system (100) is in liquid communication with an anhydrous ammonia tank (108);
iia. Adding anhydrous ammonia from the anhydrous ammonia tank (108) into the recirculation conduit (104) while recirculating the slurry, thereby dissolving said anhydrous ammonia in the slurry and forming an alkaline nitrogen enriched pre-mix;
iii. Returning said alkaline nitrogen enriched pre-mix to the deep pit;

wherein the amount added of anhydrous ammonia is sufficient to result in an alkaline nitrogen enriched pre-mix having a pH within the range of 8.0-9.9.

To avoid adding too much ammonia, it is preferably to control the addition based on the pH measured in the tank (102). Hence, in one embodiment, the pH value of the content in the tank (102) is measured continuously.

Continuing to refer to FIG. 6, another aspect relates to a system for reducing foam formation in deep pits of swine rearing facilities with slatted floors comprising:
a) a premixing system (100) comprising:
   a tank (102) adapted for receiving slurry from the deep pit;
   a recirculation conduit (104) in liquid communication with the tank (102), the recirculation conduit being connected to the tank (102) through an outlet (101) and an inlet (103);
   a recirculation pump means (106) in connection with the recirculation conduit (104), the recirculation pump means (106) being adapted for pumping the slurry from the tank (102) through the recirculation conduit (104) and back into the tank (102), the recirculation pump means (106) being configured for controlling the flow of the slurry through the recirculation conduit (104);
b) an anhydrous ammonia tank (108) in liquid communication with the recirculation conduit (104); and
c) a pH sensor system adapted for measuring the pH value of the slurry in the tank (102) and in the deep pit (300).

In one embodiment, the amount added of anhydrous ammonia is sufficient to result in an alkaline nitrogen enriched pre-mix having a pH within the range of 8.0-9.8, e.g. within the range of 8.1-9.7, such as within the range of 8.2-9.6, e.g. within the range of 8.3-9.5, such as within the range of 8.4-9.4, e.g. within the range of 8.5-9.3, such as within the range of 8.5-9.2, e.g. within the range of 8.5-9.1, such as within the range of 8.6-9.0.

In one embodiment, the system comprises an electronic control unit configured to receive data on pH values transmitted from the pH sensor system; wherein the control unit, in response to the received data, is configured to signal to the user of the premixing system when the pH level has reached a preset value in the range of 8.0 to 9.8, e.g. within the range of 8.1-9.7, such as within the range of 8.2-9.6, e.g. within the range of 8.3-9.5, such as within the range of 8.4-9.4, e.g. within the range of 8.5-9.3, such as within the range of 8.5-9.2, e.g. within the range of 8.5-9.1, such as within the range of 8.6-9.0.

In another embodiment, the electronic control unit, in response to the received data, is configured to send a warning signal either to the farmer or to a contractor that the pH level of the content in the tank (102) and/or the slurry in the pit (300) has reached a preset value in the range of 8.0 to 9.8, e.g. within the range of 8.1-9.7, such as within the range of 8.2-9.6, e.g. within the range of 8.3-9.5, such as within the range of 8.4-9.4, e.g. within the range of 8.5-9.3, such as within the range of 8.5-9.2, e.g. within the range of 8.5-9.1, such as within the range of 8.6-9.0.

When returning the treated slurry (alkaline nitrogen enriched pre-mix) to the pit, it is preferably performed under circulation of the slurry in the pit.

In one embodiment, step iii is performed while circulating the slurry in the slurry pit.

In another embodiment, step iii is performed by returning the treated slurry below the surface level and the foam layer of the slurry in the pit.

In another embodiment, the system for reducing foam formation in deep pits of swine rearing facilities with slatted floors comprises a stirrer (500) adapted for circulating the slurry in the deep pit (300). To avoid ammonia emission during the procedure, and to enable the dissolution of the anhydrous ammonia in the slurry, the premixing system is in another embodiment sealed from the surrounding atmosphere after performing step i, and before initiating step iia.

In another embodiment, the steps i-iii are repeated until the pH of the slurry in the deep pit is within the range of 8.0-9.9, such as within the range of 8.0-9.8, e.g. within the range of 8.1-9.7, such as within the range of 8.2-9.6, e.g. within the range of 8.3-9.5, such as within the range of 8.4-9.4, e.g. within the range of 8.5-9.3, such as within the range of 8.5-9.2, e.g. within the range of 8.5-9.1, such as within the range of 8.6-9.0.

The pH should preferably be targeted to max. 9.0. This will effectively stop methane gas emission without increasing the ammonia emission.

To enable the dissolution of the anhydrous ammonia in the slurry, it is preferable to optimize the contact surface of the anhydrous ammonia and the slurry by filling the recirculation conduit (104) with slurry, and reducing the amount of air in the same.

Hence, in one embodiment, the outlet (101) from the tank (102) is positioned below the slurry surface level of the slurry in the tank (102) during the operation of method step iia.

In one embodiment, the anhydrous ammonia is released into the recirculation conduit (104) from a pressure tank. In this situation, it is crucial that flow rate of slurry is so fast that it can absorb/solubilise the anhydrous ammonia to avoid an explosion. In one embodiment, the flow rate of the slurry in the recirculation conduit (104) is at least 500 litres per minute, such as at least 600 litres per minute, e.g. at least 700 litres per minute, such as at least 800 litres per minute, e.g. at least 900 litres per minute, such as at least 1000 litres per minute, e.g. at least 1200 litres per minute, such as at least 1500 litres per minute, e.g. at least 2000 litres per minute, such as at least 3000 litres per minute, e.g. at least 4000 litres per minute, such as at least 5000 litres per minute, e.g. at least 6000 litres per minute, such as at least 7000 litres per minute, e.g. at least 10.000 litres per minute.

In another embodiment, the amount of anhydrous ammonia added to the slurry in the recirculation conduit (104) is within the range of 200-3000 grams per cubic meter slurry, e.g. within the range of 300-2900 grams per cubic meter slurry, such as within the range of 400-2800 grams per cubic meter slurry, e.g. within the range of 500-2700 grams per cubic meter slurry, such as within the range of 600-2600 grams per cubic meter slurry, e.g. within the range of 700-2500 grams per cubic meter slurry, such as within the range of 800-2400 grams per cubic meter slurry, e.g. within the range of 900-2300 grams per cubic meter slurry, such as within the range of 1000-2200 grams per cubic meter slurry, e.g. within the range of 1100-2100 grams per cubic meter slurry, such as within the range of 1200-2000 grams per cubic meter slurry, e.g. within the range of 1300-1900 grams per cubic meter slurry, such as within the range of 1400-1800 grams per cubic meter slurry, e.g. within the range of 1500-1700 grams per cubic meter slurry.

Any combination of the intervals of flow rate of slurry in the recirculation conduit (104) and amount of anhydrous ammonia added to the slurry in the recirculation conduit (104) is within the scope of this invention. Due to the risk of explosion, the inventor has not performed tests to where the exact limits are.

In one embodiment, the anhydrous ammonia is injected into the slurry in the recirculation conduit (104), and wherein the anhydrous ammonia tank (108) is an anhydrous ammonia pressure tank.

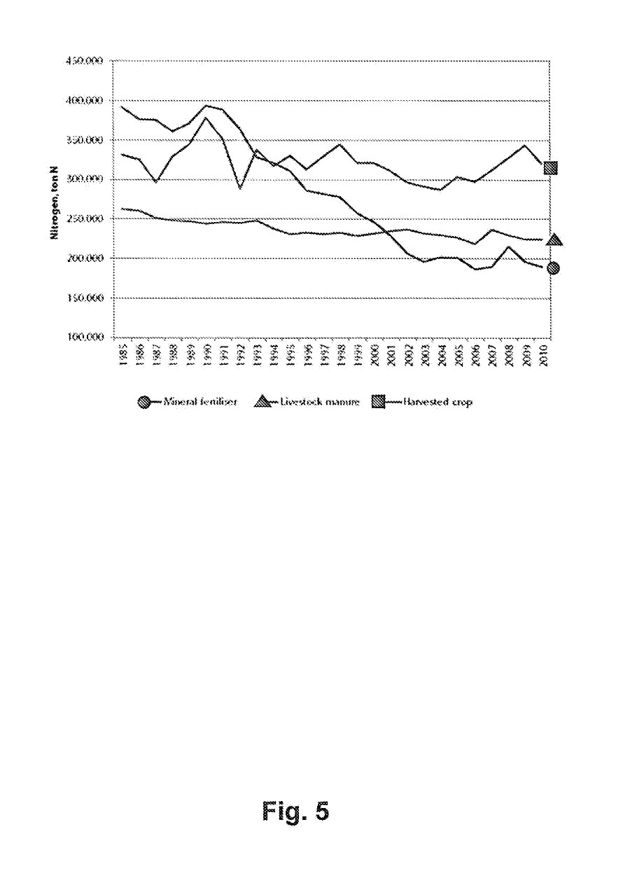

With the use of slurry as a fertilizer, it is a world-wide challenge to adjust the nutrient values to match the plant needs. From FIG. 5, it can be seen how much reduction there has been in the use of commercial fertilizer in Denmark, where the use of organic fertilizer has remained stable. This paradigm shift is resulting in a much higher focus on the use of organic fertilizer and the need to optimise the nutrient value it represents.

Amongst many types of nutrients, there is always a lack of sulphur in slurry, which prevents the use of slurry for full fertilising. When the slurry is being treated in a system for reducing foam formation according to the present invention, the system allows for a very efficient way of adjusting the sulphur values at the same time. Sulphur acid can be used with great advantage for this purpose, as 96% concentrated sulphuric acid contains 0.570 g of sulphur per litre. As previously mentioned, the addition of acid to slurry can be very dangerous, but if the pH value is increased before addition, it is possible to add sulphuric acid without lowering the pH below the buffer in the slurry, thereby avoiding triggering the bicarbonates to release the carbon dioxide (foaming) and the formation of H₂S. Sulphur is also a methane gas inhibitor, and will help to control the methane production if the pH should drop below the 8.5 level again (due to the buffering effect of the solid matter present in slurry).

Hence, in one embodiment, the premixing system (100) is in liquid communication with a sulphuric acid tank (110); further comprising the steps of:
iib. Adding sulphuric acid into the recirculation conduit (104) from a sulphuric acid tank (110) while recirculating the alkaline nitrogen enriched pre-mix, thereby dissolving said sulphuric acid in the alkaline nitrogen enriched pre-mix and forming a first alkaline nitrogen and sulphur enriched pre-mix; wherein the amount added of sulphuric acid to the alkaline nitrogen enriched pre-mix is sufficient to result in a first alkaline nitrogen and sulphur enriched pre-mix having a pH within the range of 7.5-9.0; wherein the pH of the first alkaline nitrogen and sulphur enriched pre-mix is lower than the corresponding alkaline nitrogen enriched pre-mix;
iic. Adding anhydrous ammonia into the recirculation conduit (104) from an anhydrous ammonia tank (108) while recirculating the first alkaline nitrogen and sulphur enriched pre-mix, thereby dissolving said anhydrous ammonia in the first nitrogen and sulphur enriched pre-mix and forming a second alkaline nitrogen and sulphur enriched pre-mix; wherein the amount added of anhydrous ammonia to the first alkaline nitrogen and sulphur enriched pre-mix is sufficient to result in a second alkaline nitrogen and sulphur enriched pre-mix having a pH within the range of 8.0-9.9; wherein the pH of the first alkaline nitrogen and sulphur enriched pre-mix is lower than the corresponding second alkaline nitrogen and sulphur enriched pre-mix.

In one embodiment, the pH sensor system comprises at least two pH sensors. The pH-sensor can either communicate continuously to the control unit or at specific time points, sending the pH-value of the slurry by wireless communication, where after the control unit correlates the actual pH-value with the pH-value which is predetermined. When the actual pH-value is higher than the predetermined pH-value, an e-mail or an SMS is sent to a predetermined address or an alarm in form of a sound or a light can be switched on. The pH-sensor may also communicate via cable. The cable may in one embodiment be of a length to reach both the slurry pit (300) and the tank (102). Alternatively, the pH-value can be checked manually.

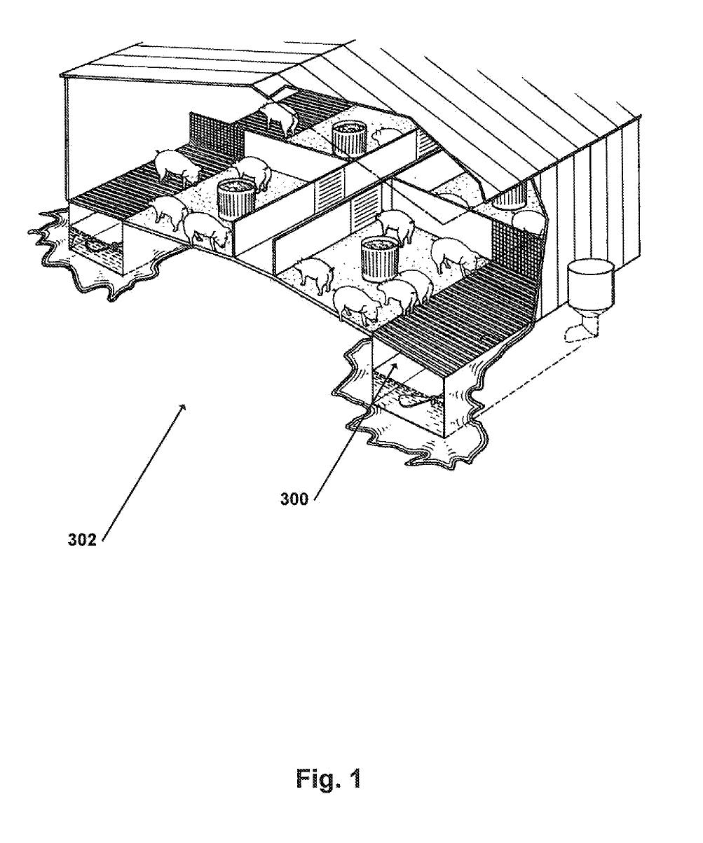

The control unit can be integrated into the pH-sensor or it can be a separate unit. In another embodiment, the system for reducing foam formation in deep pits of swine rearing facilities with slatted floors comprises a sulphuric acid tank (110) in liquid communication with the recirculation conduit (104). Referring now to FIG. 7, in another embodiment, the system for reducing foam formation in deep pits of swine rearing facilities with slatted floors comprises a pump means (600) connected through a conduit (602) to the tank (102), the pump means (600) being adapted for pumping the slurry from the deep pit (300) (FIGS. 2 and 7) of a deep pit swine barn (302) (FIG. 1) through the conduit (602) and into the tank (102). In another embodiment, the system for reducing foam formation in deep pits of swine rearing facilities with slatted floors comprises a deep pit (300).

Continuing to refer to FIG. 7, in still another embodiment, the premixing system (100) is a mobile system. In a specific embodiment, the premixing system (100) is part of a slurry tanker.

In one embodiment, the recirculation conduit (104) is adapted for returning the ammonia treated and/or sulphuric acid and ammonia treated slurry to the deep pit. In another embodiment, the system for reducing foam formation in deep pits of swine rearing facilities with slatted floors comprises a programmable manipulating means (600) operatively associated with pump means (602); wherein the pump means (602) is connected through a conduit (604) to the tank (102); wherein the programmable manipulating means (600) can be operated to move the inlet (606) of the pump means (602) in a continuous motion along the distance between the slurry surface level of the deep pit and the bottom of the deep pit.

Referring to FIG. 7, in yet another embodiment, the system for reducing foam formation in deep pits of swine rearing facilities with slatted floors comprises a programmable manipulating means (600) operatively associated with a pump means (602); wherein the pump means (602) is connected through a conduit (606) to the tank (102); wherein the pump means (602) is adapted for operating in a pumping mode and a stirring mode; wherein the programmable manipulating means (600) is configured to move the pump means (602) in a predetermined pattern, depending on the mode of the pump means (602).

In the present context, the term “liquid communication” is to be understood as a form of connection between elements in the form of conduits such as for example pipes and tubes through which a liquid content is transported.

While this invention has been particularly shown and described with references to preferred embodiments thereof, it will be understood by those skilled in the art that various changes in form and details may be made therein without departing from the scope of the invention encompassed by the appended claims.

### REFERENCES

100 premixing system

101 outlet

102 tank

103 inlet

104 recirculation conduit

106 recirculation pump means

108 anhydrous ammonia tank

110 sulphuric acid tank

300 deep pit

302 deep pit swine barn

500 stirrer

600 programmable manipulating means

602 pump means

604 conduit

606 inlet

1. A method for reducing foam formation in deep pits of swine rearing facilities with slatted floors comprising:
i. Transporting at least a part of the slurry from a deep pit of a deep pit swine rearing facility into a premixing system comprising:
a tank adapted for receiving slurry from the deep pit;
a recirculation conduit in liquid communication with the tank, the recirculation conduit being connected to the tank through an outlet and an inlet;
a recirculation pump means in connection with the recirculation conduit, the recirculation pump means being adapted for pumping the slurry from the tank through the recirculation conduit and back into the tank, the recirculation pump means being configured for controlling the flow of the slurry through the recirculation conduit; wherein the premixing system is in liquid communication with an anhydrous ammonia tank;
iia. Adding anhydrous ammonia from the anhydrous ammonia tank into the recirculation conduit while recirculating the slurry, thereby dissolving said anhydrous ammonia in the slurry and forming an alkaline nitrogen enriched pre-mix;
iii. Returning said alkaline nitrogen enriched pre-mix to the deep pit;
wherein the amount added of anhydrous ammonia is sufficient to result in an alkaline nitrogen enriched pre-mix having a pH within the range of 8.0-9.9.

2. A method according to claim 1, wherein step iii is performed while circulating the slurry in the slurry pit.

3. A method according to claim 1, wherein the premixing system is sealed from the surrounding atmosphere after performing step i, and before initiating step iia.

4. A method according to claim 1, further comprising repeating the steps i-iii until the pH of the slurry in the deep pit is within the range of 8.0-9.9.

5. A method according to claim 1, wherein the outlet from the tank is positioned below the slurry surface level of the slurry in the tank during the operation of method step iia.

6. A method according to claim 1, wherein the flow rate of the slurry in the recirculation conduit is at least 500 litres per minute.

7. A method according to claim 1, wherein the amount of anhydrous ammonia added to the slurry in the recirculation conduit is within the range of 200-3000 grams per cubic meter slurry.

8. A method according to claim 1, wherein the anhydrous ammonia is injected into the slurry in the recirculation conduit, and wherein the anhydrous ammonia tank is an anhydrous ammonia pressure tank.

9. A method according to claim 1, wherein the premixing system is in liquid communication with a sulphuric acid tank; further comprising the steps of:
iib. Adding sulphuric acid into the recirculation conduit from a sulphuric acid tank while recirculating the alkaline nitrogen enriched pre-mix, thereby dissolving said sulphuric acid in the alkaline nitrogen enriched pre-mix and forming a first alkaline nitrogen and sulphur enriched pre-mix; wherein the amount added of sulphuric acid to the alkaline nitrogen enriched pre-mix is sufficient to result in a first alkaline nitrogen and sulphur enriched pre-mix having a pH within the range of 7.5-9.0;
wherein the pH of the first alkaline nitrogen and sulphur enriched pre-mix is lower than the corresponding alkaline nitrogen enriched pre-mix;
iic. Adding anhydrous ammonia into the recirculation conduit from an anhydrous ammonia tank while recirculating the first alkaline nitrogen and sulphur enriched pre-mix, thereby dissolving said anhydrous ammonia in the first nitrogen and sulphur enriched pre-mix and forming a second alkaline nitrogen and sulphur enriched pre-mix; wherein the amount added of anhydrous ammonia to the first alkaline nitrogen and sulphur enriched pre-mix is sufficient to result in a second alkaline nitrogen and sulphur enriched pre-mix having a pH within the range of 8.0-9.9; wherein the pH of the first alkaline nitrogen and sulphur enriched pre-mix is lower than the corresponding second alkaline nitrogen and sulphur enriched pre-mix.

10. A system for reducing foam formation in deep pits of swine rearing facilities with slatted floors comprising:
a) a premixing system comprising:
a tank adapted for receiving slurry from the deep pit;
a recirculation conduit in liquid communication with the tank, the recirculation conduit being connected to the tank through an outlet and an inlet;
a recirculation pump means in connection with the recirculation conduit, the recirculation pump means being adapted for pumping the slurry from the tank through the recirculation conduit and back into the tank, the recirculation pump means being configured for controlling the flow of the slurry through the recirculation conduit;
b) an anhydrous ammonia tank in liquid communication with the recirculation conduit; and
c) a pH sensor system adapted for measuring the pH value of the slurry in the tank and in the deep pit.

11. A system according to claim 10, further comprising:
d) an electronic control unit configured to receive data on pH values transmitted from the pH sensor system; wherein the control unit, in response to the received data, is configured to signal to the user of the premixing system when the pH level has reached a preset value in the range of 8.0 to 9.5.

12. A system according to claim 10, further comprising:
e) a sulphuric acid tank in liquid communication with the recirculation conduit.

13. A system according to claim 10, further comprising:
f) a pump means connected through a conduit to the tank, the pump means being adapted for pumping the slurry from the deep pit of a deep pit swine barn through the conduit and into the tank;

14. A system according to claim 10, further comprising:
g) a stirrer adapted for circulating the slurry in the deep pit.

15. A system according to claim 10, further comprising:
h) a deep pit.

16. A system according to claim 10, wherein the premixing system is a mobile system.

17. A system according to claim 10, wherein the pH sensor system comprises at least two pH sensors.

18. A system according to claim 10, wherein the recirculation conduit is adapted for returning the ammonia treated and/or sulphuric acid and ammonia treated slurry to the deep pit.

19. A system according to claim 10, further comprising:
i) a programmable manipulating means operatively associated with pump means;
wherein the pump means is connected through a conduit to the tank; wherein the programmable manipulating means can be operated to move the inlet of the pump means in a continuous motion along the distance between the slurry surface level of the deep pit and the bottom of the deep pit.

20. A system according to claim 10, further comprising:
i) a programmable manipulating means operatively associated with a pump means;
wherein the pump means is connected through a conduit to the tank; wherein the pump means is adapted for operating in a pumping mode and a stirring mode;
wherein the programmable manipulating means is configured to move the pump means in a predetermined pattern, depending on the mode of the pump means.
